(19) United States
(12) Patent Application Publication
(10) Pub. No.: US 2021/0137765 A1
(43) Pub. Date: May 13, 2021

(54) Passive-dynamic correction device for hallux valgus and associated deformities

(71) Applicant: Jacek Marek Dygut, Warszawa (PL)

(72) Inventor: Jacek Marek Dygut, Warszawa (PL)

(21) Appl. No.: 16/884,044

(22) Filed: May 27, 2020

(30) Foreign Application Priority Data
Jun. 4, 2019 (PL) P.340145
Apr. 16, 2020 (EP) 20020181.2

(51) Int. Cl. A61H 1/02

(52) U.S. Cl. CPC A61H 1/0266; A61H 2201/169; A61H 2201/1642; A61H 2001/027

(57) ABSTRACT

The invention is a passive-dynamic hallux valgus correction device (described as HalluxSTOP) and coexisting static defects of the feet with the function of passive and dynamic valgus correction, often with coexisting transversely flat and flat-valgus feet. The device strength the weak and stretches the contracted feet muscles, restoring the physiological balance of the pulling power of muscles. It has a dynamizing and relaxing function with tonus balancing between muscles. Also, it has a passive function consisting of stretching extra-articular and articular contractures. The device is used in prevention (prevents the development of the above-mentioned feet defects) and treatment (inhibits the deepening of the above-mentioned feet defects and restores the physiological feet architecture. The invention is applicable in the field of non-operative orthopedic treatment and medical rehabilitation as well as in recreational sport as an additional exercise device, e.g. of the fitness type.

### TECHNICAL FIELD

The invention relates to the correction of the static feet deformities and is applicable in the field of the conservative orthopedic treatment (non-operative orthopedic treatment) and medical rehabilitation for restoring the physiological shape of the feet arches. It corrects static transverse flatfoot with associated the hallux valgus and Plano-valgus foot.

It can also be used in recreational sport as an additional exercise device, e.g. of the fitness type.

### BACKGROUND ART

Many years of research presented in scientific reports raise the issue of static feet defects. Despite the enormous effort, the causes of valgus, flat-valgus and transversely flat foot are still not fully understood. It is known, however, that the formation of hallux valgus (HV) may result in the appearance of the flat-valgus foot, and if deformities changes begin with the flat-valgus foot, as a consequence of further deformities, hallux valgus often appears.

Effective treatment must seek to remove the causes of deformities. The starting point of the defect which is the hallux valgus (the last link of the cause-effect chain) is in most clinical cases the lifting of the transverse or longitudinal arches of the feet (the first link of the cause-effect chain). The corrective effect on the valgus big toe without the prior reconstruction of flattened and dynamically inefficient transverse arches and longitudinal feet will not lead to the final correction. It is only a seeming, temporary, cosmetic effect, affecting the patient's psyche more than it actually reduces foot deformities.

Treatment and prevention must be of a cause-effect nature. The cause of static deformation of the feet is the overloading weakening of the dynamic apparatus, i.e. the activities of the muscles stabilizing the transverse and longitudinal arches of the feet and the stretching of the ligamentous-capsule apparatus, which in a passive manner maintains their shape and correct alignment of the toes (dynamic arches of the fingers).

The final effect of static foot deformities are:
loss of two front support points in a tripod, which is the foot
the hallux valgus
the tendency to form mallet or clawed toes of the second (II) to the fourth (IV) with the fifth (V) toe varus.

This happens as a result of a spatial change in the pulling power of muscles and muscle attachments that accompany the flattened or inverted metatarsal bones.

Currently, at the initial stages of the advancement of foot deformities, patients are recommended non-invasive treatment using various types of orthoses or shoe inserts. It has been assessed that in many cases the therapeutic effect is not entirely satisfactory. It boils down only to the cosmetic effect, slightly affecting the reduction of the pain level perception.

Attempts to correct the hallux valgus are limited to big toe abduction splints or inserts between the toes. They do not affect the correction of the longitudinal and transverse arches of the feet, the collapse of which is the most common cause of the defect. These devices have only a passive stretching function and do not affect dynamic (muscular) correction of the defect.

Recently, there have also been products that elastically abduct the big toes of both feet. These types of orthoses strengthen the toe adductor muscles, deteriorating the valgus defect. However, they are present on the market due to the visual abduction of the big toes during the exercise.

### DISCLOSURE OF INVENTION

The subject of the invention is a passive-dynamic hallux valgus correction apparatus (hereinafter referred to as HalluxSTOP) and coexisting static defects of the feet with the function of passive and dynamic valgus correction, often with a coexisting transversely flat and flat-valgus feet. The passive-dynamic apparatus strength the weak and stretches the contracted feet muscles in the above-mentioned forms of static defects, restoring the physiological balance of the pulling power of muscles. It has a dynamizing and relaxing function with tonus balancing between muscles, synergists and feet antagonists.

In addition, it has a passive function consisting in stretching extra-articular and articular contractures. The device is used in prevention (prevents the development of the above mentioned feet defects) and treatment (inhibits the deepening of the above mentioned feet defects and restores the physiological architecture of the feet conditioning its proper static function during standing and dynamic during walking).

The HalluxSTOP is a muscle strengthening and stretching device responsible for the development of static foot defects, mainly of the hallux valgus. It can be divided into the distal part responsible for passive correction and the proximal part responsible for the dynamic correction of hallux valgus. Using the device restores transverse and longitudinal physiological arches of the feet.

The device is a structure consisting of a rigid guide element, i.e. a guide with a variable cross-sectional shape, inelastic finger straps located in the distal part of the guide element and an elastic element in the proximal part being a ball or rotary ellipsoid with a through-hole located in the central part thereof, shaped adapted to the shape of the cross-section of the rigid guide element.

The rigid guide element, i.e. the guide, is the body of the device. It can be in the form of a rod with a variable cross-section or a tube with a variable cross-section with a length of at least the length of a human foot, but not longer than 400 mm and a cross-section width enabling an elastic element to be inserted. The guide can be made of wood, metal or plastic.

In the distal part of the guide, there is a fastening of straps forming loops for fingers.

In the first embodiment of the invention, the attachment of the straps consists in placing a rigid, for example, metal, frame-shaped handle in a hollow through a hole in the rigid guide element such that it forms two holes on both sides of the guide element through which the straps for fingers are threaded.

In the second embodiment of the invention, the fastening consists of sewn the width of two straps in two places in the central part of the length of these straps folded together and sewn on both sides of the guide element in such a way that they form a space, i.e. a passage channel enabling the insertion of a rigid guide between the sewn straps. After inserting the stitched straps onto the guide, their sliding along the rigid guide element is blocked by the belt blockade element made in the form of a pressed element blocking the straps on the guide element.

The straps that make up the loops are made of inelastic material, and the length and width are chosen so that they easily surround the toes. Toe loops are created due to the fact that the end parts of the straps are fitted with elements that ensure the stability of the loop size and adjust the loop size depending on the size of the toes, for example with velcro or clamping elements. The central part of the device according to the invention is a ball-shaped or rotary ellipsoidal elastic element with varying degrees of hardness and diameter of 50 mm-200 mm and 50 mm-250 mm, respectively. Through the central part of the elastic element, there is a through passage with a cross-sectional shape adapted to the cross-sectional shape of the rigid guide element, through which the through-passage spring element is slid over the guide. The elastic element is pulled over the guide until the feet with the loops on the toes are able to surround the elastic element supinationally. To prevent movement of the elastic element on the rigid guide it is blocked by blockade elements on both sides of the inserted elastic element. The blockade elements are made of a material that with resistance it is moved on the rigid guide element.

Thanks to such a construction, the distal part of the device, i.e. the loop-shaped straps attached to the rigid guide bar, attached to the fingers, creates a passive stretching force on contracted extra-articular soft tissues—passive correction. This happens when slowly setting the hallux valgus in abduction in relation to the second II toe with simultaneous heels approaching movement to each other until the heels contact the medial side.

The deepening of the toe abduction occurs when the heels come closer together so-called both hindfoot adduction, which results in a kind of “wrapping” or “surrounding” by the medial elevations of both feet the elastic element. The pressure of the medial foot elevation on an elastic ball or ellipsoidal element reduces the distance between the inner edges of the feet and heels.

As a result of mutual proximity of both feet, with the simultaneous squeezing of the elastic element, a dynamic resistance force is generated, and thus gradually strengthening are the muscles of the toes abductors—dynamic correction.

The size of the loop and the size of the elastic element are selected so that it is possible to change the exercise planes. The rotation of the slipping feet on the elastic element allows performing exercises in two main planes:

a) plantar i.e. horizontal or frontal—toe correction

b) sagittal, i.e. setting both feet in supination, where the plantar surfaces “look” at each other—correction of the arches of the feet.

### Advantageous Effects of the Inventions

In the device according to the invention, the correction is based on the common correction principle based on the action of three parallel forces. Two parallel forces adduct to the median plane the big toes and heels (both hindfoot)—action into the medial of the feet. At the same time, a third parallel force is applied in the opposite direction, makes a counterforce at the level of the metatarso-phalangeal joints—action to the side of the feet. The device according to the invention is a passive-dynamic device acting in the plantar and sagittal plane which is not applied by other “anti-hallux” devices available on the market.

The systematic use of the device according to the invention consequently leads to the recovery of the anatomical tendon system with the restoration of the spatial correct positioning of the ligamentous. The physiological parameters of the dynamic arches are restored with their alignment in the plantar plane and other arches of the feet.

In addition, this procedure leads not only to the correction of the valgus setting of the big toes (I) (hallux valgus) and the varus setting of the fifth toe (V) (quintus varus), but also to the tendency to the clawed and mallet setting of the toes.

### BRIEF DESCRIPTION OF THE DRAWINGS

The subject of the invention is shown in the examples of implementation in the drawing in which:

FIG. 1 is a perspective view of the passive-dynamic device of the first embodiment of the invention,

FIG. 2 is a perspective view of the passive-dynamic device of the second embodiment of the invention,

FIG. 3 shows a view of the elements of FIGS. 2 and 3 in the form of a guide with the elastic element blocked by the blockade elements in three views.

### DESCRIPTION OF EMBODIMENTS

The individual elements visible in the drawings are marked as follows:

1—elastic element,

2—rigid guide element, i.e. a guide, passing through the through-hole in the elastic element,

3—sliding block of the elastic element on the guide,

4—inflexible straps forming loops for the big toes,

5—elements enabling the adjustment of the loop diameter by fastening straps, e.g. with “Velcro”,

6—fastening of inelastic straps (4) to guide (2),

7—the hollow through the hole in the rigid guide element through which the fastening of inelastic straps passes,

8—passage channel for fastening the straps on the guide element created by sewing the width of two straps (4) in two places in the central part of the length of these straps

9—belt blocade element

The device consists of the following parts: an elastic element (1), which may be a ball or rotary ellipsoid with a through the channel in the central part, a rigid guide element, i.e. guide (2), having the form of a rod or tube; sliding blocks (3) of the elastic element (1) on the guide (2), inelastic straps (4) forming loops for the big toes; elements enabling the adjustment of the diameter of the loops on the big toes by fastening (4) straps Velcro (5), sewn to the straps (4); and fastening the straps (4) to the guide (2) in the first and the second embodiment of the invention.

In the first embodiment of the invention, the fastening of the straps (4) to the guide (2) is carried out by means of a rectangular rigid handle (6), made in the shape of a frame, which is inserted into the hollow elongated through-hole (7), made in the guide (2) in the distal part, so that the rigid handle (6) forms two holes through which the straps (4) forming the loops are pulled.

In the second embodiment of the invention, the fastening of the straps (4) to the guide (2) is made by stitching the straps (4) in the central part in two places after being applied to each other at a distance enabling the formation of the passage channel (8), through which the straps are slid over the guide (2). After sliding the straps (4) over the rigid guide element, their sliding is blocked by belt blocade element (9), which is e.g. a clamping element.

In both embodiments, the guide (2) has a length of at least an average length of a human foot. The cross-section of the guide (2) may have the shape of any geometrical figure. The cross-section of the guide (2) determines the shape of the through-hole in the central part of the elastic element (1), since the elastic element (1) is slid onto the guide (2) with slight resistance. The elastic element (1) can be in the form of a ball or a rotary ellipsoid.

In the embodiment shown in FIGS. 1 and 2 (FIG. 1 and FIG. 2), the guide (2) is in the form of a cylinder, which has a circle in cross-section, and the elastic element (1) is in the form of a ball. The elastic element (1) has a passage channel passing through the axis of rotation, which passage channel in cross-section is a circle (FIG. 3).

The elastic element (1), due to the passage channel located in the central part of the elastic element, is slid over the guide (2) to a height enabling to be embraced with feet in supination manner with simultaneous placement of the big toes into the loops made of straps (4).

After sliding it, it is blocked by sliding blocks (3) on the guide (2) on both sides of the poles of the elastic element (1) so that it does not move on the guide (2) (FIG. 1 and FIG. 2). The straps (4) are made of inelastic material with a width enabling to surround the big toes.

The size of the loop is regulated, for example, with (5) “Velcro” sewn to the straps.

The rehabilitation action with the device according to the invention takes place in two the planes: in the plantar plane and in the sagittal plane of the feet.

### Action in Plantar Plane

The device according to the invention allows the big toes abduction so-called passive correction by bringing the heels closer together (hindfoot adduction) and the pressure of the medial eminence of the feet on the elastic element (third contra-parallel force, from the medial to the lateral side of the feet).

This is the effect of “wrapping”, “surrounding” the medial eminence of both feet on the elastic element and reducing the distance between the inner edges of the feet and heels. In this way, a dynamic resistance force is generated, gradually strengthening the abductor hallucis muscles of the big toes in both feet (dynamic correction).

The movement of getting closer the heels each other (proximal insertion of the abductor hallucis muscles) and big toes both feet (distal insertion of the abductor hallucis muscles) is resisted by a central elastic element, which with repetitive movements with resistance leads to a strengthening of the strength and resting tonus of the abductor hallucis muscles.

### Action in the Sagittal Plane

HalluxSTOP allows changing the exercise plane to the sagittal plane with the feet in supination, which affects the correction of the proximal (posterior) part of the longitudinal arch of the feet. During the exercises of the supination type, the calcaneus with the heels insertion of the Achilles tendon is positioned in the adduction and supination.

The heels tendons are positioned on a bowstring, setting both calcanea in the varus manner with simultaneous dynamic consolidation of this position by strengthening the medial heads of the calf triceps muscles.

In this way, hindfeet regain its physiological position with the heels axis tilted from 0 to 6 degrees for valgus (gradual elimination of pronation of the flat-valgus feet).

Abducted and pronated a forefoot thanks to the applied supination and adduction forces gradually regain proper physiological alignment, with the sagittal plane passing through the center of the ankle joint, the second metatarsal bone, and the second toe.

The course of the mechanical axis of the lower limb in its distal part is restored to physiological form. HalluxSTOP during reciprocal exercises (repetitive cycles and series), in addition to strengthening short muscles, strengthens long muscles due to the necessity of, among others forced supination feet setting.

This results in the gradual restoration of the physiological balance between the synergistic muscles which abduct the big toes and the antagonist muscles that adduct big toes (balancing the moments of force acting on the metatarsal-phalangeal the I joints in the plantar plane in the feet).

The posterior tibial muscles (the main dynamic stabilizer of the longitudinal arch and the transverse arch) and the tibial anterior are mainly strengthening with the bringing closer of the muscle insertions. Simultaneously with the distance between the muscle inserts, the muscles that are their antagonists are strengthened, i.e. the peroneus longus and brevis muscles.

Thanks to this strengthening and stretching treatment, the dynamics of muscle groups are balanced, which guarantees the correct shape of the transverse arches and the distal (front) part of the longitudinal arches in the feet.

The device according to the invention is primarily intended to prevent static foot defects (preventive effect). It can also be used at the stage of:

Ia—the initial development of the defect, i.e. functional (muscular) deficiency.

Ib—with excessive stretching (laxity) of the passive ligamentous-capsule apparatus.

II—with current extra-articular contractures.

IIIa—structural changes at the joint level (phase of contracture and capsular fibrosis).

In the case of IIIa, however, this must be preceded by the mobilization of the big toes (and other toes) in accordance with the Kaltenborn-Evjent concave-convex principle. Mobilization of the toes is necessary to prevent the creation of the breaking out and decentration force that can damage the hyaline cartilage of the metatarsophalangeal joint I (and other manually corrected toes) in the feet.

IIIb—with the advanced form of the defect which is the hallux valgus (structural phase of ossification and fibrosis of the metatarsophalangeal joint I), or other structurally consolidated static foot defects, the use of the device is contraindicated.

Such cases are eligible for surgical treatment. However, the device can be used as a postoperative device, effectively preventing recurrence of feet deformities.

### INDUSTRIAL APPLICABILITY

The invention is applicable in the field of medical rehabilitation and in recreational sport (e.g. fitness).

1. Passive-dynamic hallux valgus correction device and co-existing static foot defects, characterized in that it comprises a rigid guide element (2) in the form of a guideway, two straps (4) forming two loops for two toes, which loops are attached to the guide element (2) in a distal part of the guide element (2) and an elastic element (1) placed slidably on the guide element (2) with sliding blocks (3), which elastic element (1) has a channel located in the central part of the elastic element (1), in which the guide (2) is slidably located, and the elastic element (1) is blocked by the sliding blocks (3) at a set distance from the distal part of the guide element (2), so that it is possible to the putting the feet on the elastic element (1) in supination manner with both feet when the toes of both feet are placed in loops made of straps (4).

2. The passive-dynamic device according to claim 1, characterized in that the guide element (2) is in the form of a rod or tube of variable shape in cross-section.

3. Passive-dynamic device according to claim 1, characterized in that the guide element (2) has at least the length of an average human foot and is not longer than 400 mm.

4. Passive-dynamic device according to claim 1, characterized in that the guide element (2) is made of metal, plastic or wood.

5. Passive-dynamic device according to claim 1, characterized in that the straps (4) are made of inelastic material and have a width in the range of 10 mm-50 mm and a length of 50 mm-300 mm, enabling the toes to be surrounded.

6. Passive-dynamic device according to claim 1, characterized in that the straps (4) forming the toe loops of both feet are firmly attached to the rigid guide element (2).

7. Passive-dynamic device according to claim 1, characterized in that the straps (4) forming the toe loops of both feet are fastening to the guide element (2) by a fastening (6,7), in which the straps (4) are separated or by a fastening (8,9), in which the straps (4) are sewn together along the guide (2).

8. Passive-dynamic device according to claim 7, characterized in that the fastening (6,7) is in the form of a rigid handle (6) made in the shape of a frame inserted into a through-hole (7) hollowed out in the distal part of the guide element (2), which frame after sliding it into the hole (7) of the guide element (2) it has two windows to pull the straps (4) forming separate loops for the toes of both feet.

9. Passive-dynamic device according to claim 7, characterized in that the fastening (8,9) is in the form of a passage channel (8) formed after sewn the width of two straps (4) in two places in the central part of the length of these straps, folded together and sewn on both sides of the guide element (2) and a belt blockade element (9) is made in the form of a pressed element blocking the straps (4) on the guide element (2), and a passage channel (8) of the straps has a dimension that allows for sliding into it the guide element (2) with a slight resistance.

10. Passive-dynamic device according to claim 1, characterized in that the straps (4) forming the loops for fixing the toes of both feet have an adjustable size adapted to the circumference of the toes, which loops fix the toes to the level of the first metatarsal-phalangeal joint.

11. Passive-dynamic device according to claim 1, characterized in that the elastic element (1) is a ball or rotary ellipsoid equipped with a through passage passing through the central part of the elastic element (1).

12. Passive-dynamic device according to claim 10, characterized in that the through passage in the elastic element (1) has a variable shape adapted to the shape of the rigid guide element (2).

13. Passive-dynamic device according to claim 10, characterized in that the elastic element (1) has a diameter in the range of 50 mm-200 mm in the case of a ball, and in the case of a rotary ellipsoid the smaller diameter is in the range of 50 mm-200 mm and the larger diameter in the range of 100 mm-250 mm.

14. Passive-dynamic device according to claim 1, characterized in that the elastic element (1) is placed on the rigid guide element (2) at a distance enabling the putting the feet on the elastic element (1) in supination manner, after inserting the toes of both feet into loops formed from strips (4).

15. Passive-dynamic device according to claim 1, characterized in that the sliding blocks (3) of the elastic element (1) are placed on both sides of the elastic element (1) slipped on the guide (2) and prevent the elastic element (1) from moving during rehabilitation exercises (1) on a rigid guide element (2) at a set distance, allowing the putting the feet around the elastic element (1) in supination manner.

16.
